(19) United States
(12) Patent Application Publication
(10) Pub. No.: US 2014/0369778 A1
(43) Pub. Date: Dec. 18, 2014

(54) Securement System

(71) Applicants: Ed Cardona, Ft. Lauderdale, FL (US); The Braun Corporation, Winamac, IN (US)

(72) Inventors: Jeffrey J. Hermanson, Culver, IN (US); Aaron E. Kiser, Royal Center, IN (US); Ed Cardona, Ft. Lauderdale, FL (US)

(73) Assignee: The Braun Corporation, Winamac, IN (US)

(21) Appl. No.: 14/120,317

(22) Filed: May 14, 2014

Related U.S. Application Data
(60) Provisional application No. 61/823,194, filed on May 14, 2013.

(51) Int. Cl. A61G 3/08; B60P 3/06; B60P 7/08

(52) U.S. Cl. CPC A61G 3/0808; B60P 7/08; B60P 3/06
USPC 410/8

(57) ABSTRACT

A securement system for securing a wheelchair in a vehicle includes a securement area having a first end, a second end, and a support surface. A first extendable restraint is fixedly attached proximate the first end. A dispensing opening extends through the support surface proximate the second end. A second extendable restraint is fixedly attached proximate the first end and extends to and through the dispensing opening.

### CROSS-REFERENCE TO RELATED APPLICATIONS

This application claims priority to co-pending U.S. Provisional Patent Application No. 61/823,194 filed on May 14, 2013, the entire content of which is incorporated herein by reference.

### FIELD OF THE INVENTION

The present invention relates to securement systems, and more particularly to wheelchair securement systems for wheelchair accessible vehicles.

### BACKGROUND OF THE INVENTION

When using a vehicle to convey a wheelchair-bound passenger, it is often desirable to transport the individual while situated in his or her wheelchair to minimize discomfort while entering and exiting the vehicle as well as throughout the entire course of travel. To do so, however, requires a system that facilitates convenient and efficient vehicle ingress and egress and properly secures both the passenger and the wheelchair once inside the vehicle.

### SUMMARY OF THE INVENTION

The present invention provides a wheelchair securement system for a vehicle having a pan for supporting the wheelchair in the vehicle and a frontwardly-positioned retractor assembly with front and rear restraints. The pan includes a subfloor permitting concealed passage of the rear restraints from the front to the rear of the pan. The addition of D-rings at the rear of the pan permits rotational movement of the rear restraints and proper connection to the wheelchair. The invention allows a wheelchair unimpeded access into and out of the vehicle and to be restrained from behind while the retractors are located in the front.

In one embodiment, a securement system for securing a wheelchair in a vehicle includes a securement area having a first end, a second end, and a support surface. A first extendable restraint is fixedly attached proximate the first end. A dispensing opening extends through the support surface proximate the second end. A second extendable restraint is fixedly attached proximate the first end and extends to and through the dispensing opening.

In one embodiment, a securement system for securing a wheelchair in a vehicle, in which the vehicle has a front end and a rear end, includes a pan defining a wheelchair securement area and including a front end, a rear end, and a support surface. The front end is oriented toward the front end of the vehicle. An enclosure is positioned at the front end of the securement area. A first restraint is operably coupled to a first retractor located within the enclosure and is extendable to a front portion of a wheelchair. A second restraint is operably coupled to a second retractor located within the enclosure and is extendable to the front portion of the wheelchair. A third restraint is operably coupled to a third retractor located within the enclosure and is extendable to a rear portion of the wheelchair. A fourth restraint is operably coupled to a fourth retractor located within the enclosure and is extendable to the rear portion of the wheelchair. A first opening extends through the pan near the rear end and the third restraint is configured to pass through the first opening. A second opening extends through the pan near the rear end and the fourth restraint is configured to pass through the second opening.

Other features and aspects of the invention will become apparent by consideration of the following detailed description and accompanying drawings.

### BRIEF DESCRIPTION OF THE DRAWINGS

FIG. 1 is a rear perspective view of a vehicle for transporting a person in a mobility device.

FIG. 2 is rear view of the vehicle of FIG. 1 illustrating portions of a securement system.

FIG. 3 is a perspective view of the securement system of FIG. 2.

FIG. 4 is a perspective view of a retractor assembly of the securement system of FIG. 2.

FIG. 5 is a perspective view of the retractor assembly of FIG. 4 with a cover portion removed.

FIG. 6 is another perspective view of the retractor assembly of FIG. 5.

FIG. 7 is another perspective view of the retractor assembly of FIG. 5.

FIG. 8 is a cross-sectional view of the securement system taken through line 8-8 of FIG. 3.

FIG. 9 is another perspective view of the pan shown in FIG. 2.

FIG. 10 is a perspective view of the pan and retractor assembly of the securement system of FIG. 2 with the cover of the retractor assembly and a support floor removed.

FIG. 11 is another perspective view of the pan and retractor assembly shown in FIG. 10.

FIG. 12 is a perspective view of a rear attachment assembly of the securement system of FIG. 2.

FIG. 13 is a perspective view of a ramp of the vehicle of FIG. 1 being unfolded.

FIG. 14 is a perspective view of a portion of the securement system during wheelchair attachment.

FIG. 15 is a perspective view of the wheelchair of FIG. 14 being loaded into the vehicle.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

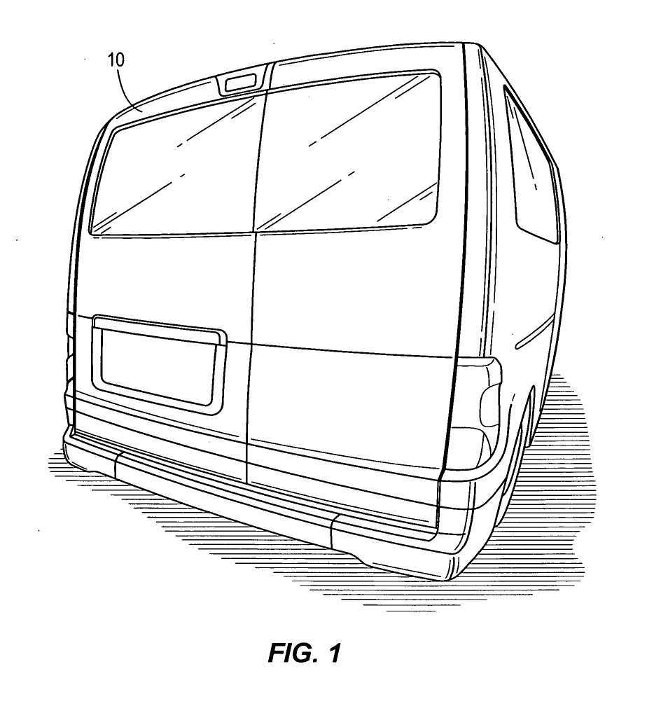

FIG. 1 illustrates an exemplary vehicle 10 for transporting a wheelchair-bound individual. The illustrated vehicle 10 is a van, but the securement system is not so limited in application and can be used with any van, SUV, light truck, or other consumer (or commercial) vehicle permitting side or rear entry of a wheelchair. In addition, while the embodiments disclosed hereafter will be described for use with a wheelchair, the securement system is applicable with any type of mobility device conventionally used to provide such assistance, to include motorized scooters, carts, and other wheeled devices.

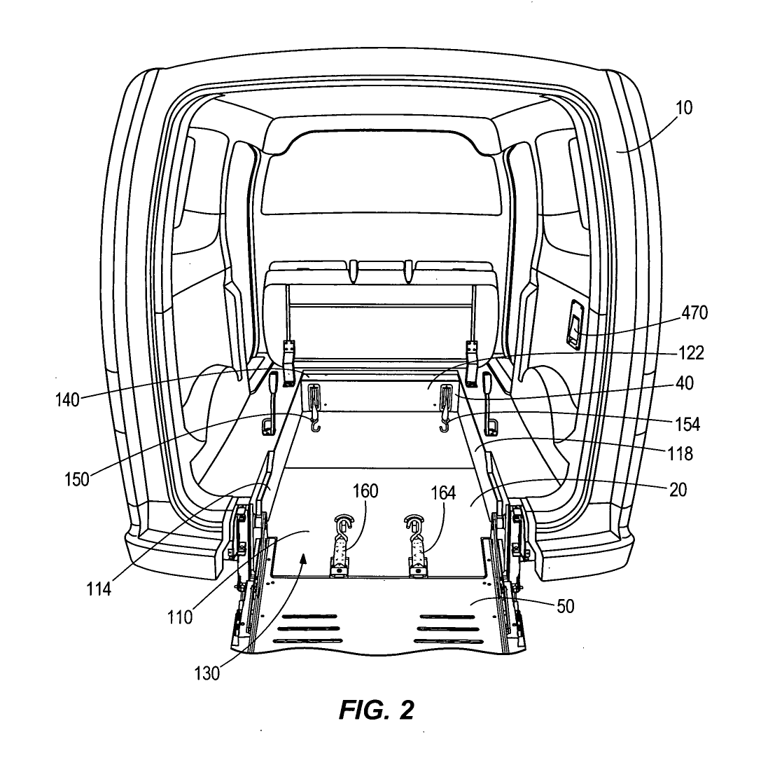

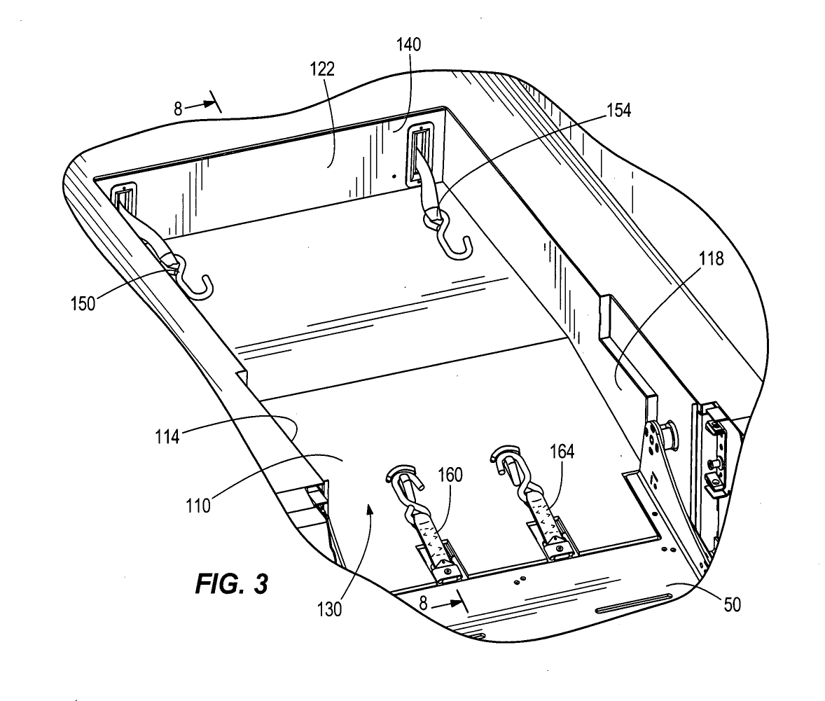

With reference to FIGS. 2 and 3, the vehicle 10, as modified, includes a securement area or pan 20 for supporting the wheelchair-bound passenger (not shown), a securement system 40 for securing the wheelchair within the pan 20, and a foldable ramp 50 for providing wheelchair access into the vehicle 10. The pan 20, additional features of which will be further described below, has a support floor 110, first and second side walls 114, 118, a front panel 122 extending between the first and second walls 114, 118, and a generally open rear portion 130. As used here, terms of relative position, such as left, right, front, and rear, are referenced as viewed from the rear of the vehicle 10 (i.e., from the perspective of FIG. 2).

The securement system 40 includes a retractor assembly 140 positioned behind the front panel 122 of the pan 20 comprising a pair of front restraints 150, 154 and a pair of rear restraints 160, 164, each with a retractor, a length of webbing, and a fastener fitted to an end of the webbing for attachment to the wheelchair, as will be further detailed. The securement system 40 is described here as a four-point securement system, but can be configured to have any number and/or arrangement of restraints suitable for securing the wheelchair.

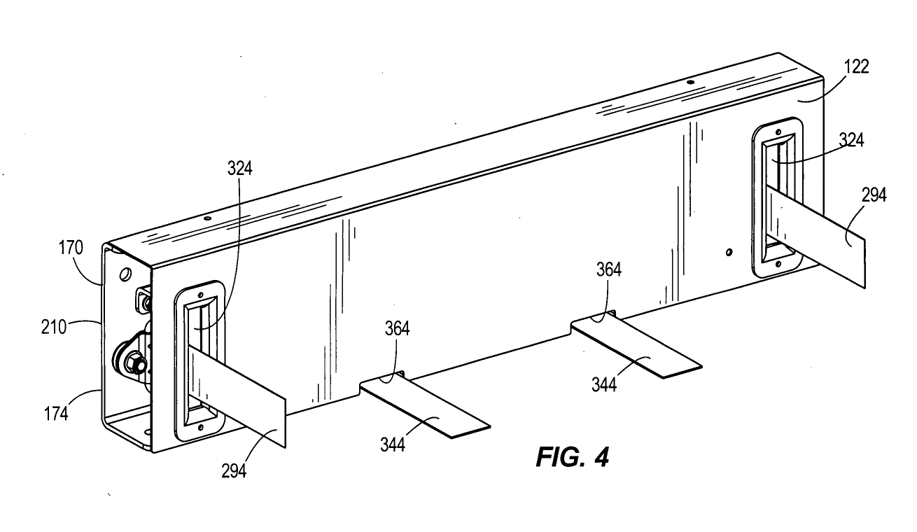

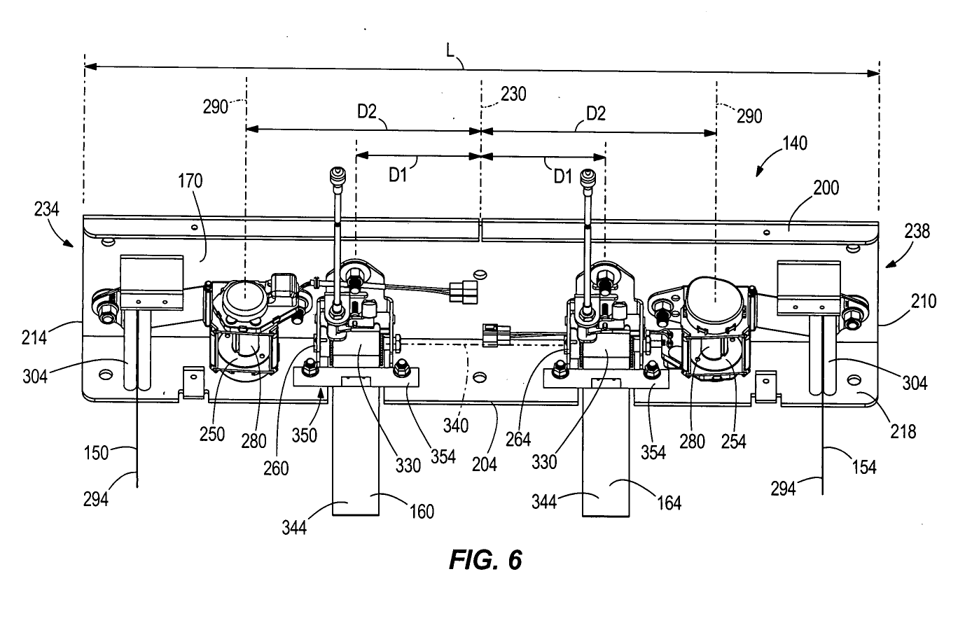

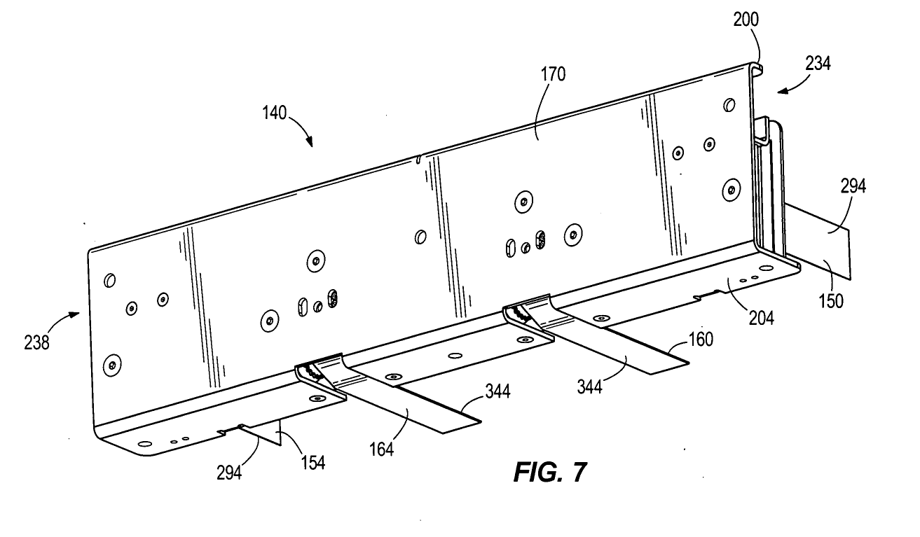

With reference to FIGS. 4-7, a support member 170 cooperates with the front panel 122 to define a cavity 174. The support member 170 can be in the form of a plate, tube, or channel and is preferably of metal construction. The support member 170 includes a first leg 200, a second leg 204 opposite the first leg 200, and a wall 210 extending between the legs 200, 204. With reference to the illustrated orientation, the support member 170 also includes a left end 214, a right end 218 opposite the left end, and defines a length L between these ends. A medial plane 230 between the left end 214 and the right end 218 further delineates a left side 234 and a right side 238 of the support member 170 (see FIG. 6). The support member 170 is oriented in the pan 20 such that the wall 210 is parallel to the front panel 122 and the legs 200, 204 extend toward the rear portion 130 of the pan 20. In other embodiments, the orientation of the support member 170 can be reversed such that the legs 200, 204 extend frontward and the wall 210 serves as a front panel for the pan 20. In either arrangement, the support member 170 is secured to the pan 20 by mechanical fasteners or in any other suitable manner.

The retractor assembly 140 includes a left front retractor 250 and right front retractor 254 that dispense/retract the front restraints 150, 154, and a left rear retractor 260 and right rear retractor 264 that dispense/retract the rear restraints 160, 164. The left and right rear retractors 260, 264 are secured to the respective left and right sides 234, 238 of the support member 170 at a distance D1 from the medial plane 230, as shown in FIG. 6. The left and right front retractors 250, 254 are secured to the left and right sides 234, 238 of the support member 170 at a distance D2 from the medial plane 230. The left retractors 250, 260 and the right retractors 254, 264 are therefore generally arranged symmetrically about the medial plane 230. In the illustrated embodiment, the distance D2 is greater than the distance D1. The distances D1, D2 can vary along the length L of the wall 210 and in other embodiments, the retractors 250, 254, 260, 264 can be arranged asymmetrically about the medial plane 230. In yet other embodiments, the rear retractors 260, 264 can be positioned further from the medial plane 230 than the front retractors 250, 254. In the illustrated embodiment, the retractors 250, 254, 260, 264 are secured to the support member 170 by a plurality of fasteners extending through the support member.

The front retractors 250, 254 each include a spool 280, a ratchet, and a locking mechanism. The spools 280 each define an axis 290 about which the straps or webbing 294 of the front restraints 150, 154 is wound and unwound. In the illustrated embodiment, the axes 290 of the spools 280 are substantially perpendicular to the first and second legs 200, 204 of the support member 170. One or more springs (not shown) rotationally bias each spool 280 to wind the webbing 294 around the spool 280. Each ratchet is a one-way ratchet having a pawl or other component (not shown) that prevents the webbing 294 from being unwound from the spool 280 until the locking mechanism is activated. In one embodiment, the locking mechanism includes a solenoid that, when energized, disengages the ratchet by displacing the pawl to allow the webbing 294 to be unwound from the spool 280. Alternatively, the locking mechanism can be any suitable electrical, mechanical, magnetic, electromagnetic and/or electromechanical arrangement for selectively disengaging the ratchet. The spool 280, ratchet, and locking mechanism are commercially available components.

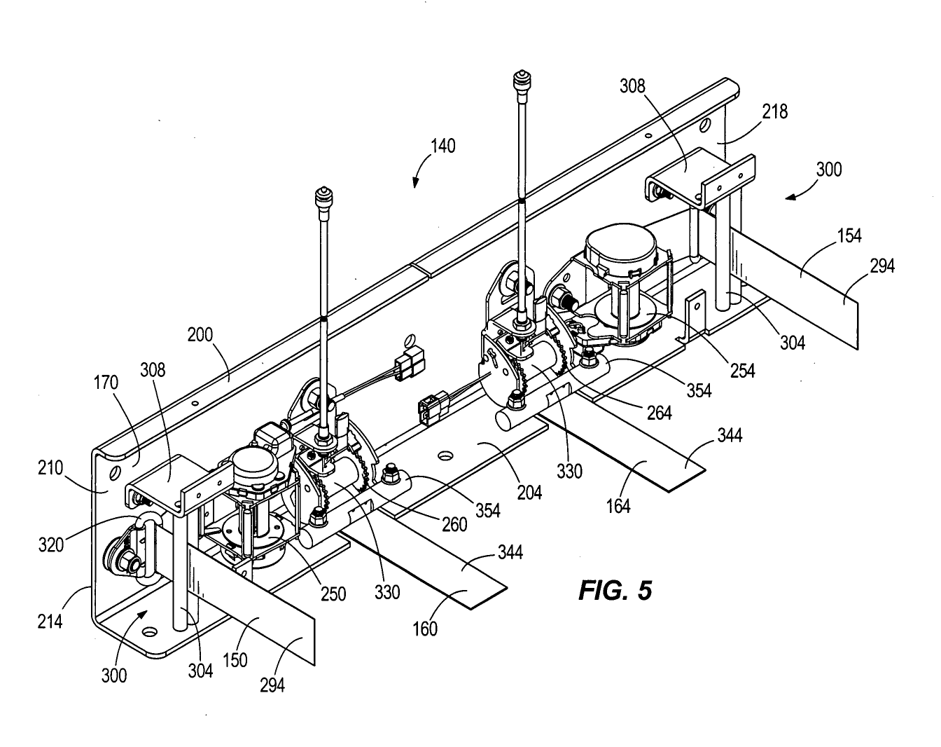

A guiding assembly 300 associated with each of the front retractors 250, 254 includes a pair of generally cylindrical bars or rollers 304 supported between the second leg 204 of the support member 170 and a bracket 308 extending from the wall 210 of the support member, as shown in FIG. 5. The rollers 304 are positioned with axes parallel to the axes 290. A ring 320 coupled to the wall 210 re-orients the webbing 294 to form a generally right angle between the respective retractor 250, 254 and the respective rollers 304. The webbing 294 passes between the rollers 304, which engage the webbing as it is dispensed/retracted from the respective retractor 250, 254. This maintains the orientation of the webbing 294 near the spool 280 to prevent the webbing 294 from folding, curling, or otherwise tangling on the spool 280 and further aligns the webbing 294 with openings 324 in the front panel 122. In other embodiments, the guiding assembly 300 can include any number and arrangement of brackets, rollers, slots, or channels configured to optimally align the webbing 294 with the respective retractors 250, 254.

The rear retractors 260, 264 each include a spool 330, a ratchet, and a locking mechanism. The spools 330 each define an axis 340 about which the straps or webbing 344 of the rear restraints 160, 164 is wound and unwound. In the illustrated embodiment, the axes 340 of the spools 330 are generally aligned along the length L of the support member 170 from the left side 234 to the right side 238. One or more springs (not shown) rotationally bias each spool 330 to wind the webbing 344 around the spool 330. As with the front retractors, each ratchet of the rear retractors is a one-way ratchet that prevents the webbing 344 from being unwound from the spool 330 until the locking mechanism is activated.

A guiding assembly 350 associated with each of the rear retractors 260, 264 includes a generally cylindrical bar or roller 354 coupled to the second leg 204 of the support member 170. The rollers 354 are positioned with axes parallel to the axes 340 of the spools 330 and engage the webbing 344 as it is dispensed/retracted from the respective retractors 260, 264. This precludes any folding or curling of the webbing 344 and aligns the webbing with openings 364 in the front panel 122. In other embodiments, an alternative arrangement of brackets, rollers, slots, or channels could be used to permit smooth extension and retraction of the webbing 344.

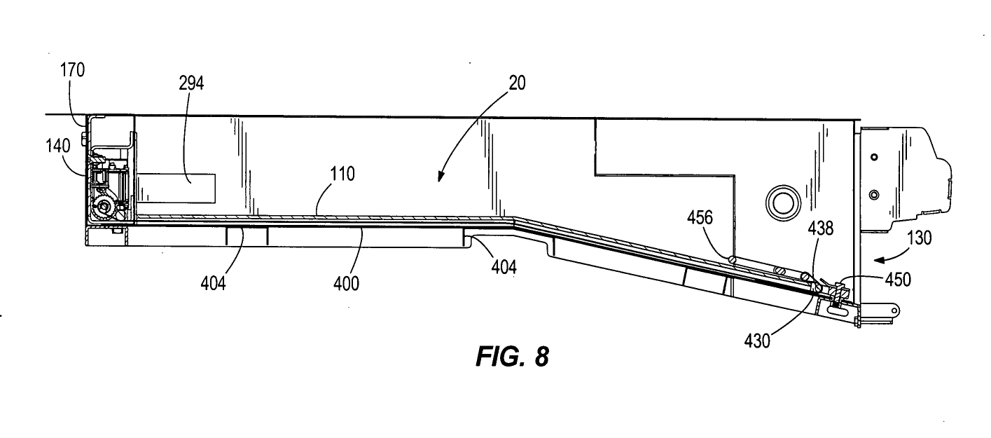

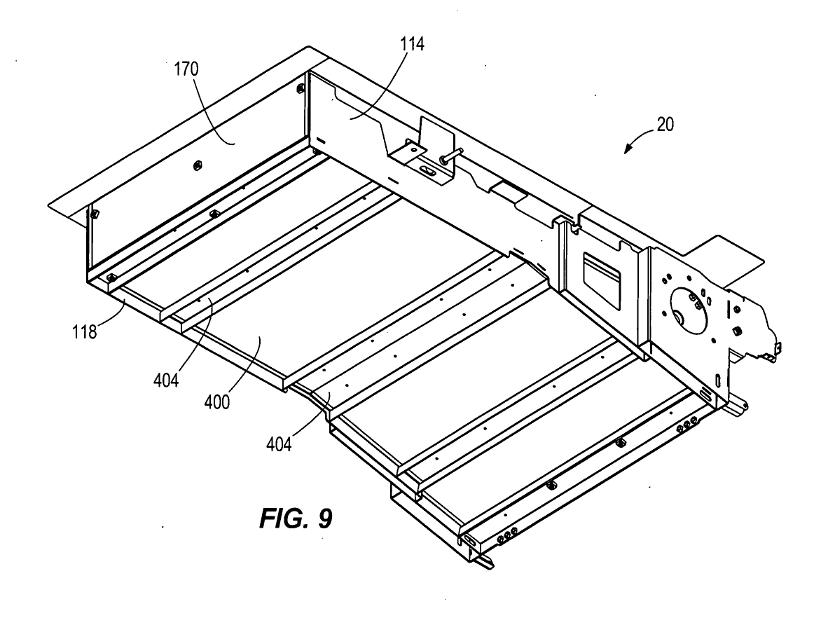

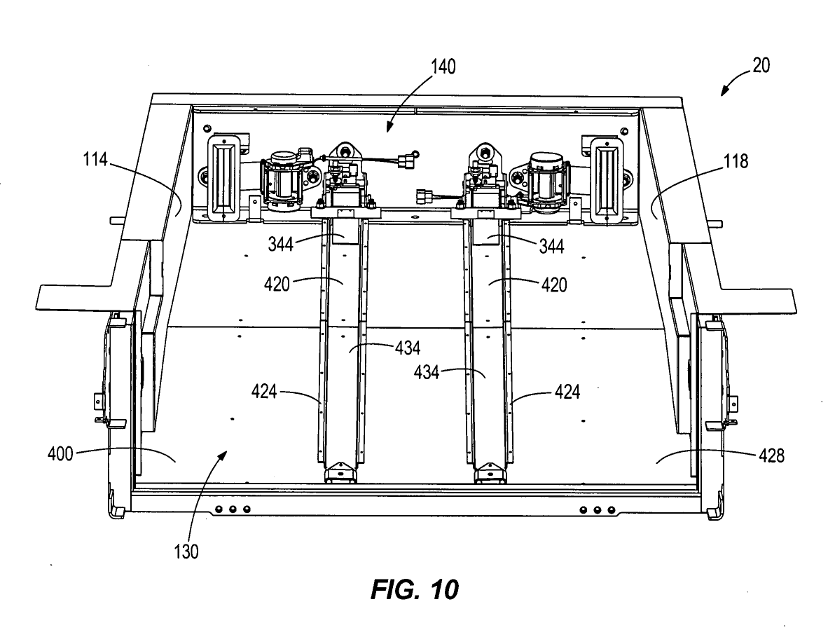

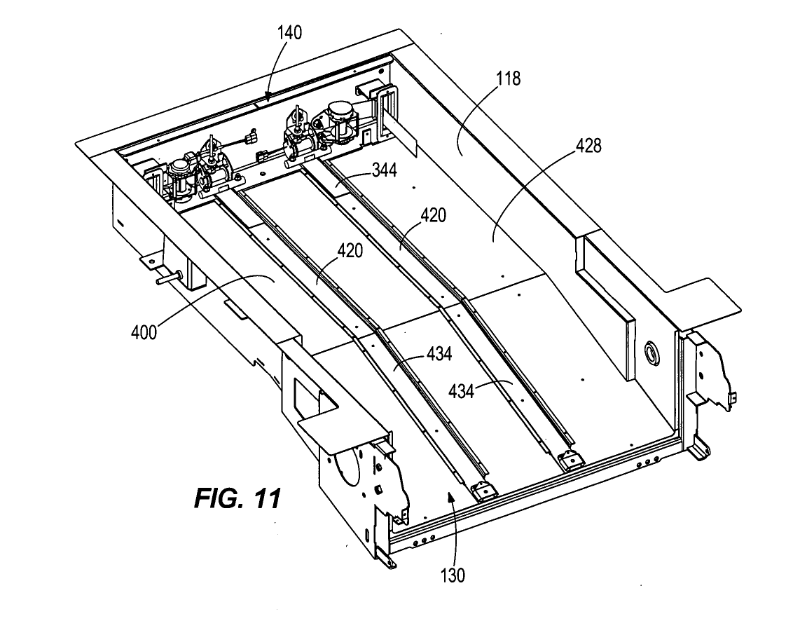

With reference to FIGS. 3 and 8-12, the pan 20 includes a subfloor 400 disposed underneath and adjacent to the support floor 110. Cross members 404 extend transversely between the first and second side walls 114, 118 to provide structural integrity underneath the subfloor 400. As shown in FIGS. 10-11, the subfloor 400 includes left and right channels 420 that extend from the retractor assembly 140 towards the rear portion 130 of the pan 20. In the illustrated embodiment, the channels 420 comprise inserts recessed into the subfloor 400 such that flanges 424 of the channels 420 are substantially flush with a top surface 428 of the subfloor 400. The channels 420 provide a depth of approximately ½″ from the flanges 424 to the channel base 434. The support floor 110 is disposed over the subfloor 400 and the channels 420 such that the channels 420 are covered by the support floor 110 when the securement system 40 is fully assembled. Referring also to FIG. 4, the channels 420 are configured to route the webbing 344 of the rear retractors 260, 264 from the openings 364 in the front panel 122 and underneath the support floor 110 so that they do not interfere with movement of the wheelchair within the pan 20. In other embodiments, the channels 420 can be integrally formed with the subfloor 400 as a single piece, and can include any shape suitable for guiding the webbing 344.

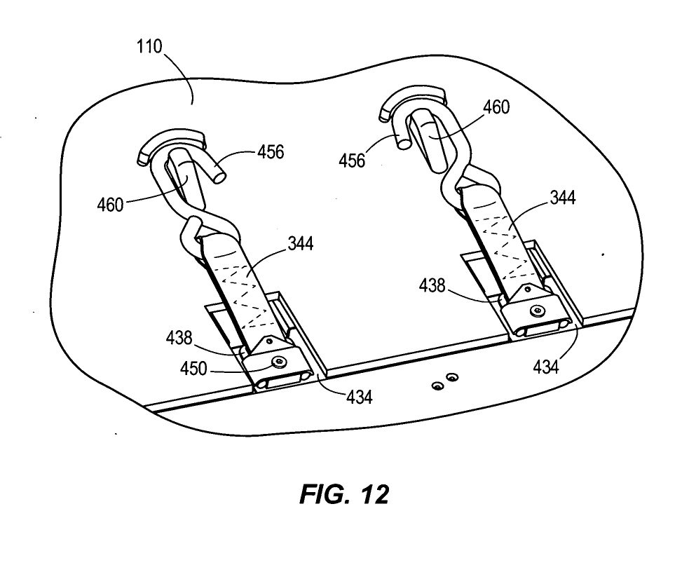

The channels 420 terminate at dispensing openings 430 through which the ends of the respective webbing 344 of each rear retractor 260, 264 pass upwardly through the support floor 110. The support floor 110 includes a recessed portion 434 proximate each dispensing opening 430 to accommodate the webbing 344. Each opening 430 includes a D-ring 438 pivotally coupled to the recessed portion 434 by a shoulder bolt 450. The webbing 344 extends through each respective D-ring 438 and is coupled to fasteners 456 in the form of S-hooks for attachment to the rear structure of the wheelchair. The pivoting D-rings 438 allow an unimpeded change of direction of the webbing 344 to reduce the “bunching” of the webbing 344 that may otherwise occur as a result of rotating the fasteners 456, and thus the end portions of the webbing 344, out of alignment with the channels 420 to accommodate differently sized wheelchairs within the pan 20. Referring to FIG. 12, the support floor 110 also includes receiving portions 460 positioned to engage the fasteners 456 of the rear restraints 160, 164 to neatly store and make readily accessible the restraints when not in use. In alternative embodiments, the S-hooks could instead be any other type of hook, karabiner, latch, tongue, or the like.

With reference again to FIG. 2, the securement system 40 includes a release lever 470 for activating the locking mechanisms of the retractors 250, 254, 260, 264. The locking and unlocking of the retractors 250, 254, 260, 264 can be accomplished in a variety of ways. As one example, the release lever 470 is coupled to a controller (not shown), such that actuation of the release lever 470 mechanically releases the locking mechanisms of the rear retractors 260, 264, and a solenoid on the release lever 470 holds the retractors 260, 264 in the unlocked state to disengage the ratchets for a predetermined time period (e.g., 50 seconds). Actuation of the release lever 470 concurrently energizes the solenoids of the front retractors 250, 254 to release the locking mechanisms of the front retractors 250, 254 for a predetermined time period (e.g., 30 seconds). During the predetermined time periods, the respective restraints 150, 154, 160, 164 can be freely pulled from the retractor assembly 140 and attached to a wheelchair. Once the predetermined time periods have elapsed, the controller automatically de-energizes the respective solenoids to engage the ratchets of the respective retractors 250, 254, 260, 264, preventing any further extension of the restraints 150, 154, 160, 164. The controller can further include a visual indicator (e.g., an LED) to indicate the locked or unlocked status of the securement system 40. In other embodiments, the securement system 40 can include separate actuators for locking and unlocking the retractors 250, 254, 260, 264.

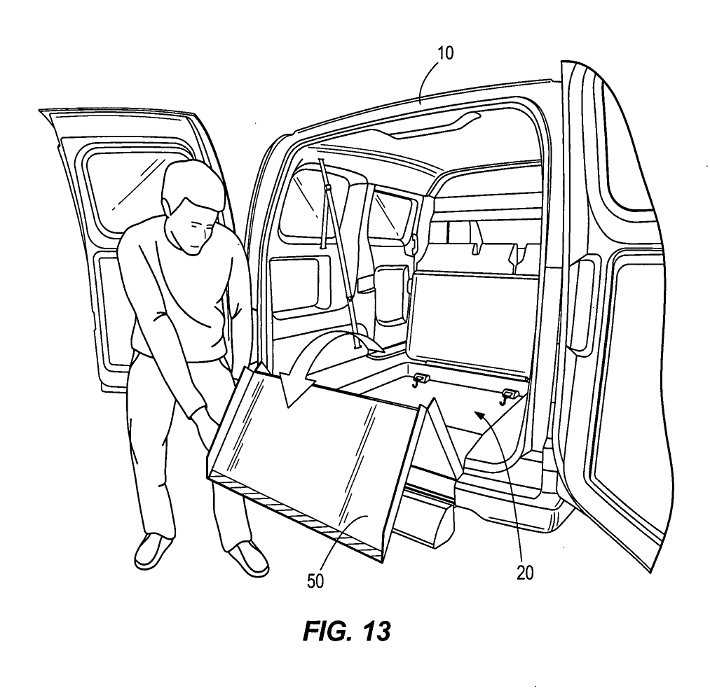

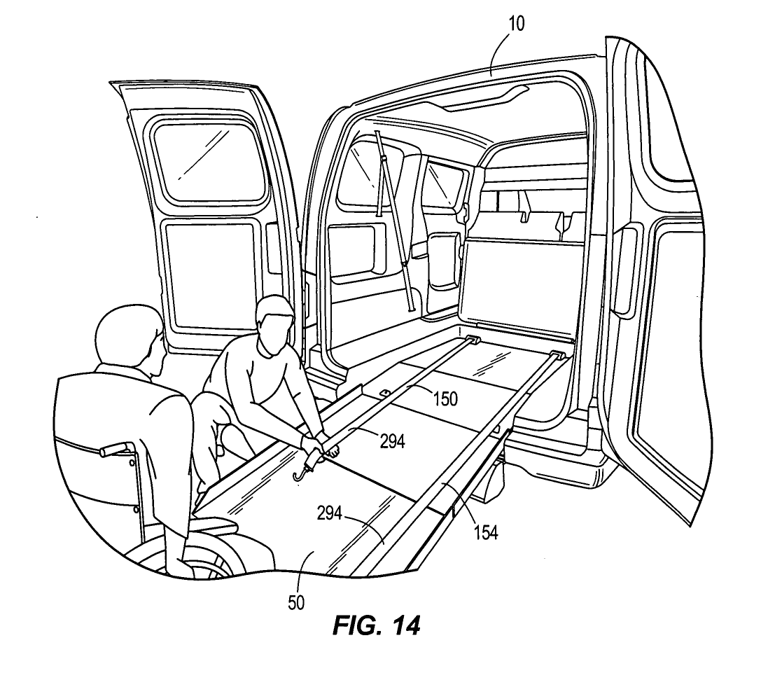

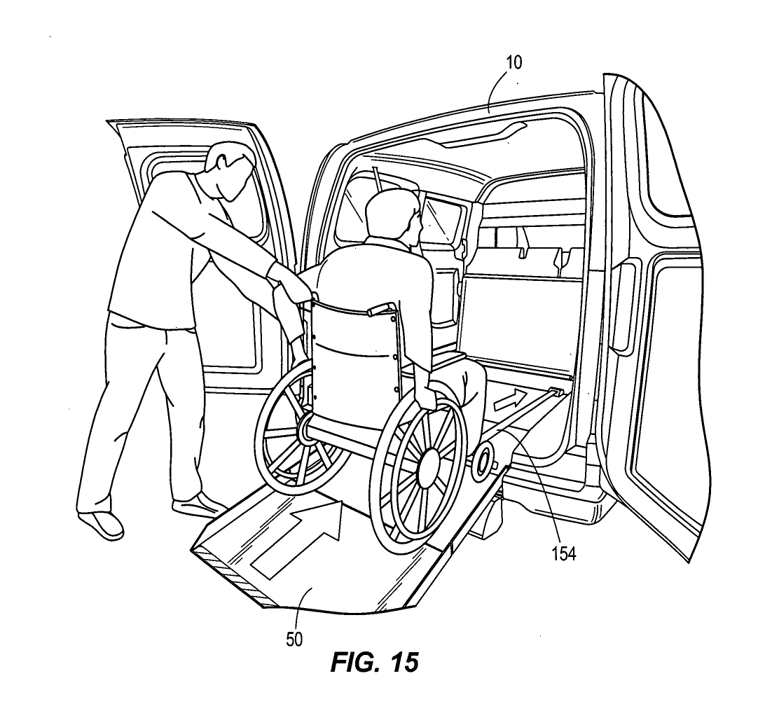

Referring to FIG. 13, to load a passenger in a wheelchair, a user (e.g., the driver of the vehicle) lowers the ramp 50 to provide access into the pan 20. The ramp 50 is located behind and folds down aft of the rear restraints 160, 164. Next, the user actuates the release lever 470 to energize the solenoids of the retractors 250, 254, 260, 264 for the predetermined time period. The solenoids disengage the ratchets to permit the restraints 150, 154, 160, 164 to be freely pulled from the retractors 250, 254, 260, 264. With the wheelchair and occupant positioned behind the vehicle 10, the user secures the front restraints 150, 154 to the front of the wheelchair, and pushes the wheelchair and the passenger up the ramp 50, as illustrated in FIGS. 14 and 15. As the wheelchair moves up the ramp, the springs of the front retractors 250, 254 wind the restraints 150, 154 back on to the spools 280 to keep the restraints relatively taught. As the rear retractors 260, 264 are located within the frontwardly-positioned retractor assembly 140 as previously described, the wheelchair is able to easily pass over the rear restraints 160, 164 concealed in the subfloor 400. Once the wheelchair and the passenger are properly positioned in the pan 20, the user extracts the rear restraints 160, 164 from the rear retractors 260, 264 and secures the fasteners 456 to the rear structure of the wheelchair. When the predetermined time periods expire, the respective solenoids are de-energized, reengaging the ratchets of the retractors 250, 254, 260, 264 and preventing each restraint 150, 154, 160, 164 from extending. As such, the wheelchair is securely held in place within the pan 20. Additional restraints, e.g., seatbelts, further secure the wheelchair occupant in position.

Various features and benefits of the invention are included in the following claims.

What is claimed is:

1. A securement system for securing a wheelchair in a vehicle, the securement system comprising:
a securement area including a first end, a second end, and a support surface;
a first extendable restraint fixedly attached proximate the first end;
a dispensing opening through the support surface proximate the second end; and
a second extendable restraint fixedly attached proximate the first end and extending to and through the dispensing opening.

2. The securement system of claim 1, further comprising a pan defining the wheelchair securement area, the pan including
a first side wall,
an opposing second side wall, and
a panel adjacent the first end between the first and second side walls.

3. The securement system of claim 2, further comprising a support member that cooperates with the panel to define an enclosure.

4. The securement system of claim 3, wherein the first restraint and the second restraint are secured within the enclosure.

5. The securement system of claim 2, further comprising a ramp operably coupled to the pan proximate the second end of the securement area, wherein the ramp is configured to provide wheelchair access into the pan.

6. The securement system of claim 1, further comprising a channel positioned between the first end and the dispensing opening, wherein the second restraint extends within the channel.

7. The securement system of claim 6, wherein the channel is positioned below the support surface.

8. The securement system of claim 1, wherein the first and second restraints are configured for attachment to a respective front and rear portion of a wheelchair.

9. The securement system of claim 4, further comprising
a first retractor configured to hold at least a portion of the first restraint, wherein the first retractor is operable to selectively retract the first restraint toward the enclosure; and
a second retractor configured to hold at least a portion of the second restraint, wherein the second retractor is operable to selectively retract the second restraint toward the enclosure.

10. The securement assembly of claim 9, further comprising a release mechanism remotely positioned from the first and second retractors, wherein the release mechanism is coupled to at least one of the first and second retractors such that the release mechanism is operable to toggle the at least one of the first and second retractors between a locked position and an unlocked position.

11. The securement system of claim 1, wherein the dispensing opening is a first dispensing opening, and wherein the securement system further comprises
a third extendable restraint fixedly attached proximate the first end;
a second dispensing opening through the support surface proximate the second end and offset from the first dispensing opening; and
a fourth restraint fixedly attached proximate the first end and extending to and through the second dispensing opening.

12. The securement system of claim 11, further comprising
a first channel positioned between the first end and the first dispensing opening, wherein the second restraint extends within the first channel; and
a second channel positioned between the first end and the second dispensing opening, wherein the fourth restraint extends within the second channel.

13. The securement system of claim 12, wherein the first and second channels are positioned below the support surface.

14. The securement system of claim 13, further comprising a subfloor disposed below the support surface, wherein the first and second channels are integrally formed with the subfloor.

15. The securement system of claim 12, wherein the first and third restraints are configured for attachment to a front portion of a wheelchair, and wherein the second and fourth restraints are configured for attachment to a rear portion of the wheelchair.

16. The securement system of claim 11, further comprising
a first retractor configured to hold at least a portion of the first restraint;
a second retractor configured to hold at least a portion of the second restraint;
a third retractor configured to hold at least a portion of the third restraint; and
a fourth retractor configured to hold at least a portion of the fourth restraint.

17. The securement system of claim 16, wherein the first retractor, the second retractor, the third retractor, and the fourth retractor are all positioned within a single enclosure.

18. The securement assembly of claim 16, further comprising a release mechanism remotely positioned from the first, second, third, and fourth retractors, wherein the release mechanism is coupled to at least one of the first, second, third, and fourth retractors such that the release mechanism is operable to toggle the at least one of the first, second, third, and fourth retractors between a locked position and an unlocked position.

19. A securement system for securing a wheelchair in a vehicle, the vehicle having a front end and a rear end, the securement system comprising:
a pan defining a wheelchair securement area and including a front end, a rear end, and a support surface, wherein the front end is oriented toward the front end of the vehicle;
an enclosure positioned at the front end of the securement area;
a first restraint operably coupled to a first retractor located within the enclosure, the first restraint extendable to a front portion of a wheelchair;
a second restraint operably coupled to a second retractor located within the enclosure, the second restraint extendable to the front portion of the wheelchair;
a third restraint operably coupled to a third retractor located within the enclosure, the third restraint extendable to a rear portion of the wheelchair;
a fourth restraint operably coupled to a fourth retractor located within the enclosure, the fourth restraint extendable to the rear portion of the wheelchair;
a first opening extending through the pan near the rear end, wherein the third restraint is configured to pass through the first opening; and
a second opening extending through the pan near the rear end, wherein the fourth restraint is configured to pass through the second opening.
